(19) United States
(12) Patent Application Publication
(10) Pub. No.: US 2026/0187735 A1
(43) Pub. Date: Jul. 2, 2026

(54) Harnessing full capacity of Green Energy to generate electricity On Demand and a safe nitrogen-hydrogen fuel for today's gasoline vehicles

(71) Applicant: BRYAN A. BAILEY, Rockville, MD (US)

(72) Inventor: BRYAN A. BAILEY, Rockville, MD (US)

(21) Appl. No.: 18/831,390

(22) Filed: Dec. 27, 2024

(51) Int. Cl. G06Q 50/06; C10L 3/00; C25B 1/04; F24H 1/10

(52) U.S. Cl. CPC G06Q 50/06; C10L 3/00; C25B 1/04; C10L 2200/0259; F24H 1/10

(57) ABSTRACT

By capturing un-utilized electric generating capacity at electric generating plants and other sources, then immediately using it to split water into oxygen and hydrogen to create stored energy, and using neutral nitrogen (N2) extracted from the atmosphere to reduce the explosive powers of hydrogen below that of gasoline, the carbon-free nitrogen-hydrogen fuel (NHV) created can be used in today's gasoline vehicles with modified tanks and carburetors and/or to generate additional electricity “on demand” without creating any CO2 air pollution.

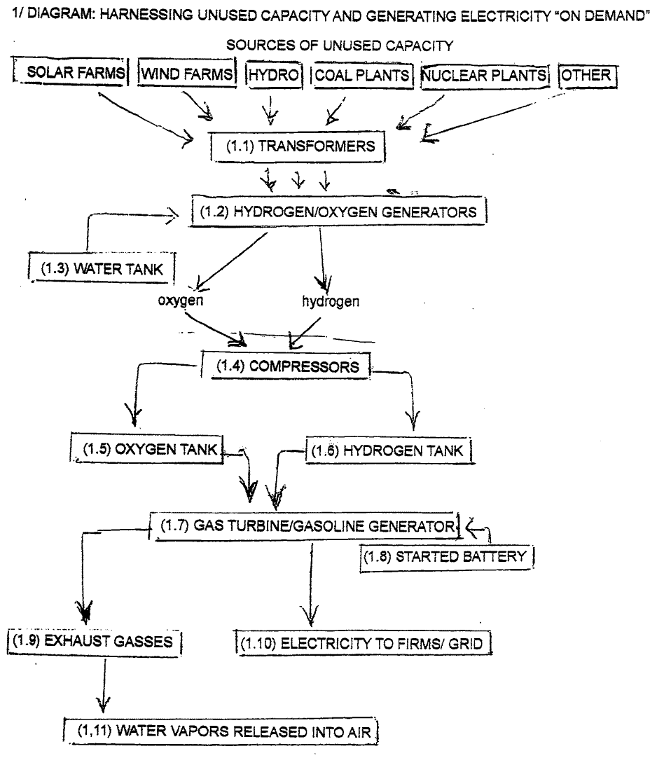

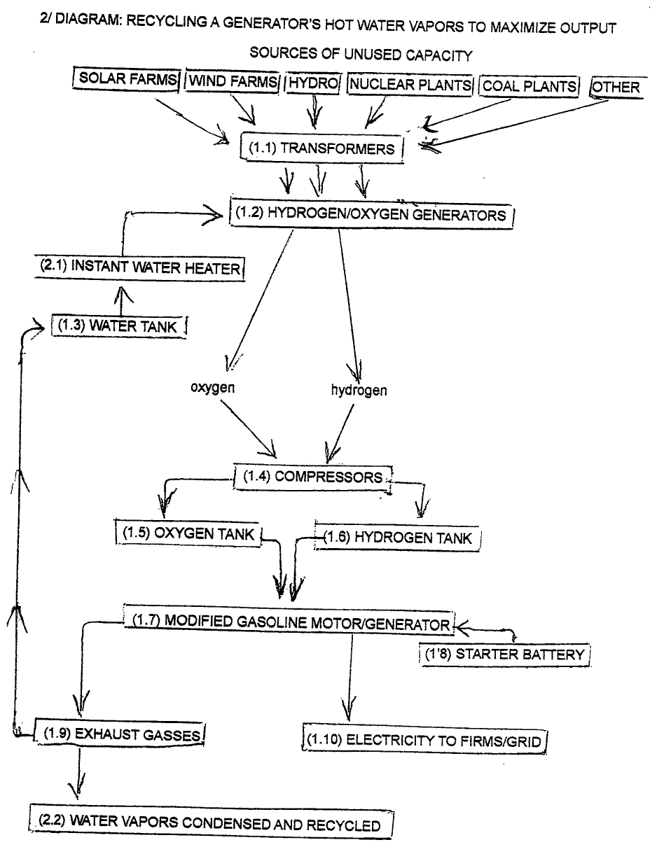

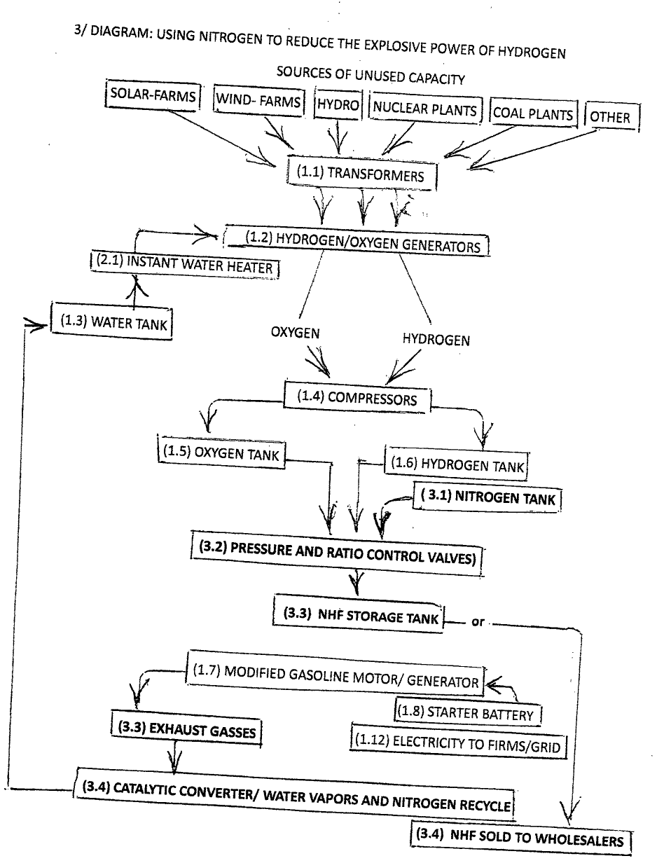

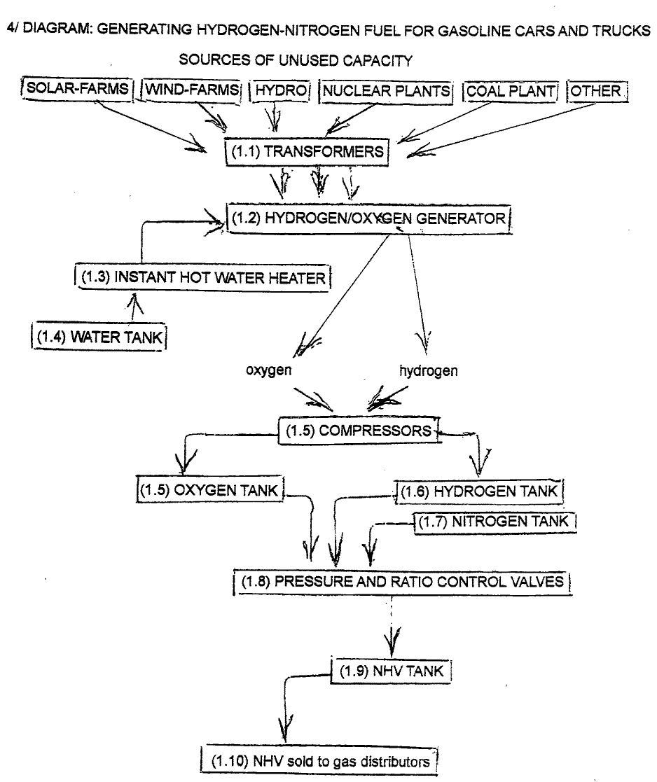

Although hydrogen has a lower level of flammability (a lower percentage of concentration in the atmosphere before it ignites) it also has a greater explosive power. Unlike today's EVs that take considerable time to recharge at recharging stations along our highways, an (NHV) would take about the same amount of time that it takes to refuel today's gasoline vehicles.

### BACKGROUND OF THE PATENT

Over the last 30 years I have seen a high percent of the huge blades wind-farms in the United States and in Spain lying idle even during a stiff breeze. On several of my tours of hydro dams and coal plants, I have also seen one or more of the huge turbines lying idle at hydro dams as the water continued to flow and the huge generator sat lying idle. When I have asked why, I have been told they cannot generate more electricity than is needed or they would burn out the wires and the transformers. In the past when I have also asked why hydrogen cannot be used to generate more electricity, or used instead of gasoline and methane in a car, I have been told hydrogen was too explosive and too dangerous.

During the last few months my curiosity was again aroused when I read articles that solar-farms in California and in Spain were creating stored energy and using it later to generate electricity. When I dug deeper, I discovered they were using towers and mirrors to concentrate the rays of the sun to melt rock salt and later using the heat to generate electricity with steam generators. At other solar-farms and wind-farms, I learned they were using batteries to store electrical power.

None of them were using an UNOBVIOUS AND COUNTERINTUTIVE method of using nitrogen N2 extracted from the air to reduce the explosive power of nitrogen below gasoline to create a nitrogen-hydrogen fuel (NHF). The NHF created would be immediately stored in huge industrial tanks and used later to generate more electricity “on demand” at these electric generating plants and/or sold to gasoline companies and private filling station owners and used in today's gasoline vehicles with modified carburetors and gas tanks. Although a single nitrogen atom has an unbalanced outer ring and is highly positive, it quickly shares an electron with another nitrogen atom to form a highly neutral N2. Only under extreme pressure and temperatures found far above those in today's radiator cooled cars and in today's diesel trucks would the two nitrogen atoms in N2 separate and become highly positive. Unlike today's EVs that require a considerable amount of electricity to recharge its cell batteries, a nitrogen-hydrogen-vehicle (NHV) would not need any. Unlike today's EVs that require a considerable amount of time to be recharged at an EV recharging station on our intra-state and enter-state highways, an NHV would only require about the same amount of time that it now takes to refuel today's gasoline vehicles. And unlike today's EVs whose cell-batterers need to be replace about every after 120,000 miles, an NHV. Like all of today's gasoline vehicles, would only need a stand car battery to start the generator and then is quickly recharged when the generator starts.

### Related Projects and Patents

1ExxonMobil's low-carbon hydrogen project at its petrochemical facility at Baytown, Texas to capture CO2 and safely store it underground.
2President George W. Bush's initiative to develop the technology for commercially viable hydrogen fuel cells in cars and trucks.
3U.S. Pat. No. 3,844,262(2001 ) by Paul Dieges which patent a method that modifies an internal combustion engine to be powered by pure hydrogen.
4The United States Department of Clean Energy's H2 HUB Clean Energy Demonstration Projects in California, Huston, the mid-west, and in New Jersey to generate hydrogen for hydrogen fuel-cell cars and to evaluate the cost effectiveness of building an underground distribution network.

intended to limit the scope or the multiple ways the claims set forth in this patent can be used. The generators, compressors, and storage tanks needed in a bare-bones nitrogen-hydrogen fuel generator are readily available and would only need to be tailored to meet the physical space and the amount of excess electricity being generated.

FIGURE ONE gives an overview of the basic processes and their sequence in a nitrogen-hydrogen fuel generating (NHV) unit at an electricity generating plant. FIGURE TWO gives a sideview picture of a stand-alone nitrogen-hydrogen-fuel unit at an electric generating plant. FIGURE THREE are pictures of the current off-the-shelf generators, compressors, and storage tanks. The basic steps and their current sequence needed to create and to produce an NHF are:

STEP (1): In Figure ONE and in FIGURE TWO, the excess electricity that could be generated at a coal-fired electric generating plant, a nuclear plant, a solar farm, and a wind farm when utilizing their full generating capacity, is depicted as (A).
STEP (2): The excess electricity from (A) would be immediately sent to a series of off-the-shelf industrial fuse boxes and voltage regulators which are collectively depicted as (B).
STEP (3): Some of the electricity in STEP (2) would be immediately used in an off-the-shelf industrial electric generator, depicted as (C), to split water from WATER TANK (D) to create oxygen and hydrogen. If an electric generating plant already has excess or an abundant supply of water, it might not need a WATER TANK (D).
STEP (4): Some of the electricity in STEP (2): would be immediately used to extract (N2) nitrogen from the air using one of the off-the-shelf NITROGEN GENERATORS depicted as (E). If the electric generating plant has limited space, it might choose to buy its N2 from a wholesaler and would not need NITROGEN GENERATOR (E).
STEP (5): Some of the excess electricity in STEP (2): would be immediately used to pressurize the oxygen and hydrogen that was created during STEP (4): and the nitrogen generated during STEP (3): using an industrial gas pressurizer depicted as (F).
STEP (6): The oxygen created during STEP (3): and pressurized during STEP (4) would be immediately stored in an OXYGEN TANK (G). It can be either sold to a whole gas distributor or released into the air and would not need to have an OXYGEN TANK (G).
STEP (7): The nitrogen extracted from the atmosphere during STEP (3): and pressurized during STEP (4) would be immediately stored in NITROGEN TANK (H).
STEP (8): The hydrogen created during STEP (3) and pressurized during STEP (4) would be immediately stored in a HYDROGEN TANK (I) and create stored energy.
STEP (9): Using a set of control valves (J), the nitrogen stored in Nitrogen TANK (I) would be used to reduce the explosive power of hydrogen from HYDROGEN TANK (I) to that below the explosive power of gasoline to create a nitrogen-hydrogen fuel (NHF).
STEP (10): The NHF created during STEP (9): would be immediately stored in an NHF TANK (K).
STEP (11): The NHF that was created during STEP (9): and stored in NHF TANK (J) during STEP (10): could be used to generate more electricity “on demand” using a standard gasoline generator (L).
STEP (12): A standard car battery (M) would be used to start the gasoline generator to generate more electricity “on demand.”
STEP (13): The NHF created during STEP (9): and stored in NHF TANK (K) during STEP (10): could also be sold to wholesale gas distributers and/or gasoline companies and independent gas station owners and used in today's gasoline vehicles with modified gasoline tanks and carburetors.

1. By using all the excess capacity of an electric generating plant to generate hydrogen and oxygen, then using (N2) extracted from the air to reduce the explosive level of hydrogen below that of gasoline, the carbon-free nitrogen-hydrogen-fuel (NHV) created would be immediately sent to an NHV holding tank to be used to generate electricity when needed and/or used in today's gasoline vehicles and diesel trucks with modified carburetors and fuel tanks. Unlike today's EVs that require a considerable amount of electricity to recharge their cell batteries, a nitrogen-hydrogen-vehicle (NHV) would not need any. Unlike today's EVs that require a considerable amount of time to be recharged at an EV recharging station on our intra-state and inter-state highways, an NHV would only require about the same amount of time that it now takes to refuel today's gasoline vehicles. And unlike today's costly EVs cell-batters that slowly degrade and need to be replaced about every 120,000 miles, an NHV would only need a standard car battery to start the generator and then be quickly recharged when the generator starts. NHV fuel would also be as safe to transport as gasoline. Unlike gasoline, any NHV leakage or spillage wound not pollute our ground waters or our streams and rivers and oceans. World-wide use of NHV fuels could drastically reduce the world's dependency on oil and the growing monopolistic powers of the oil producing nations over other nations' economies.
